(19) United States
(12) Patent Application Publication
(10) Pub. No.: US 2013/0333983 A1
(43) Pub. Date: Dec. 19, 2013

(54) LANDINGS OR CAR DOORS FOR LIFTS AND MOUNTING METHODS THEREOF

(71) Applicant: Roberto Zappa, Bergamo (IT)

(72) Inventor: Roberto Zappa, Bergamo (IT)

(73) Assignee: SEMATIC S.p.A., Osio Sotto,Bergamo (IT)

(21) Appl. No.: 14/001,675

(22) PCT Filed: Feb. 28, 2011
(86) PCT No.: PCT/IT2011/000053

§ 371 Date: Aug. 27, 2013

(51) Int. Cl. B66B 13/08

(52) U.S. Cl. CPC B66B 13/08
USPC 187/331; 187/335; 49/506

(57) ABSTRACT

Landings or car doors for lifts are provided which include a frame which defines the perimeter of an access aperture of the door, the frame comprising a pair of uprights and a pair of crossbeams, the crossbeams respectively comprising an upper horizontal sliding guide and a lower horizontal sliding guide, at least two reciprocally sliding panels to open and close the access aperture of the door. Advantageously, sliding devices and closure devices may be directly attached to each panel so that the panels are self-supporting, wherein the sliding devices couple with the sliding guides of the crossbeams to permit and guide the opening and closing movements of the panels and the closure devices are suitable to block and release the panels. Methods for mounting doors are also provided.

The present invention relates to the door of a landing or car for lifts and mounting method thereof.

Various solutions of landing or car doors for lifts are known of in the prior art which envisage the use of doors sliding together or sliding away from each other, or of telescopic doors in two or more parts.

The prior solutions envisage the use of perimetral frames attached to the structure of the lift shaft, with which the landing or car doors engage. In the prior solutions, between the perimetral frame and the doors, carriages are interposed comprising sliding rails or guide which are made separately and subsequently attached to the doors and/or to the perimetral frame to complete mounting of the doors.

The realisation of said carriages with relative sliding rails or guides entails some drawbacks in terms of mounting complexity and precision.

In fact, the carriages must be correctly mounted onto the panels and/or onto the frame to ensure the correct alignment of the panels and smooth siding of the same. In fact, improper alignment of the guides and sliding devices requires subsequent dismantling and calibration of the panels increasing installation times and costs.

Moreover, the use of carriages with separate rails and frames subsequently attached to the panels adds to the complexity and overall weight of said panels.

The purpose of the present invention is to overcome the drawbacks mentioned with reference to the prior art.

Such drawbacks and limitations are resolved by a landing or car door for lifts according to claim 1 and a mounting method according to claim 16.

Other embodiments of the door according to the invention are described in the subsequent claims.

Further characteristics and advantages of the present invention will be evident from the description below of its preferred and non-limiting examples of embodiment, wherein:

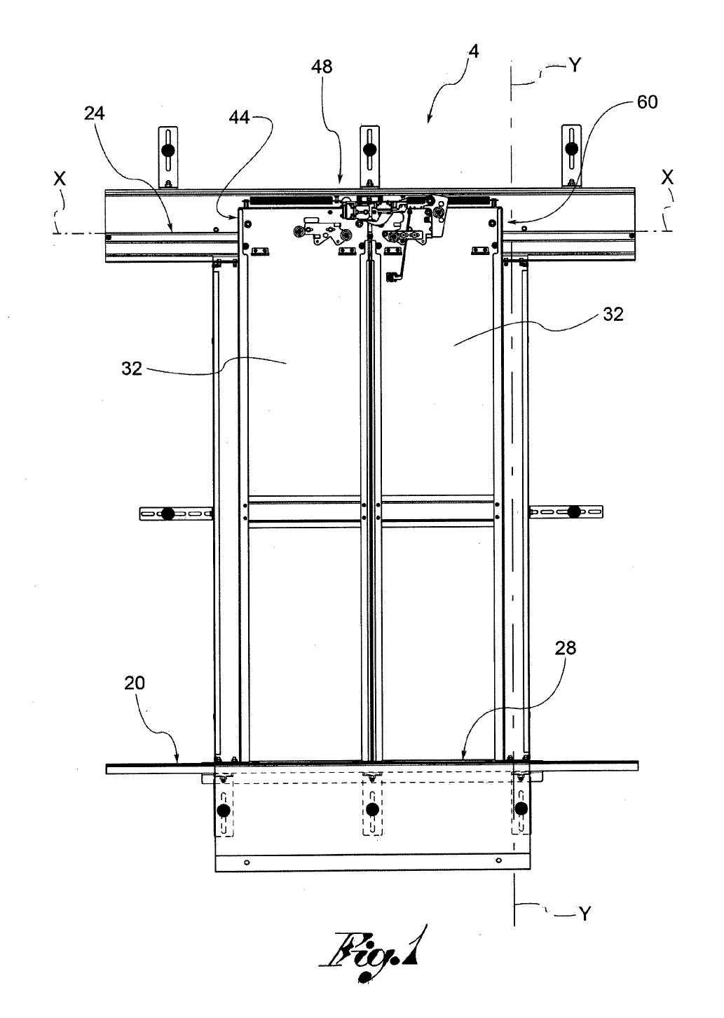

FIG. 1 shows a front view of a landing door for lifts according to one embodiment of the present invention;

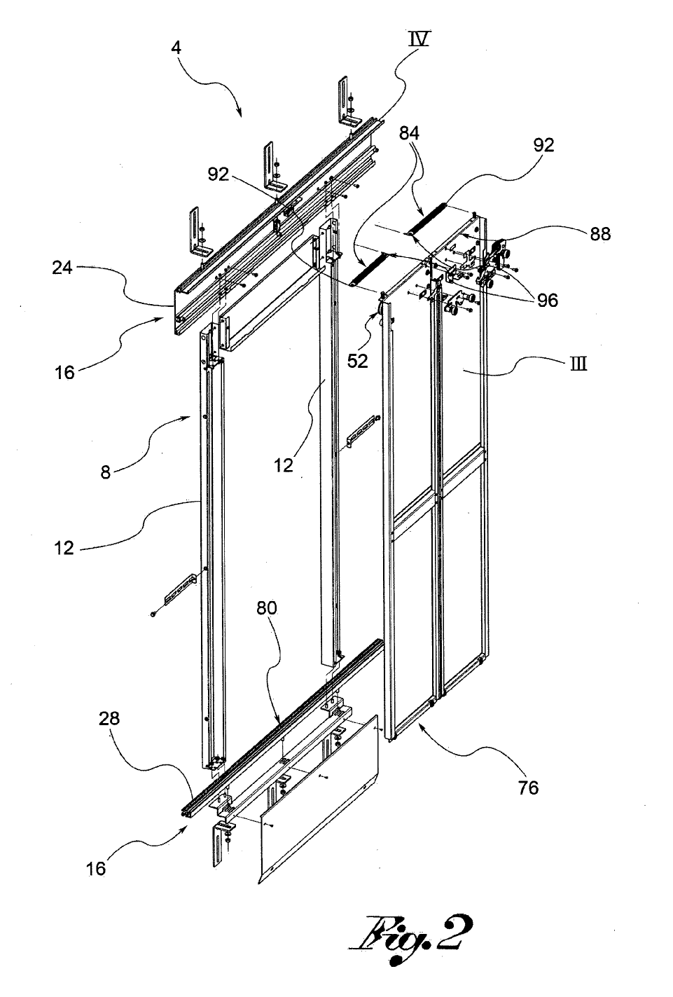

FIG. 2 shows a perspective view, in separate parts, of the door in FIG. 1;

FIG. 3 shows a perspective view, from a different angle, of the detail III in FIG. 2;

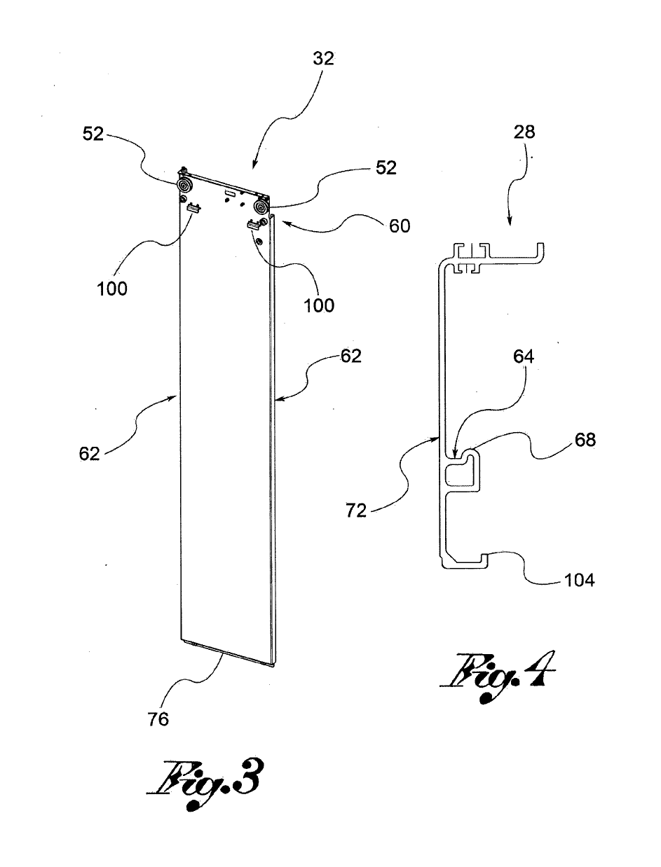

FIG. 4 shows a cross-section view, in separate parts, of the detail IV in FIG. 2;

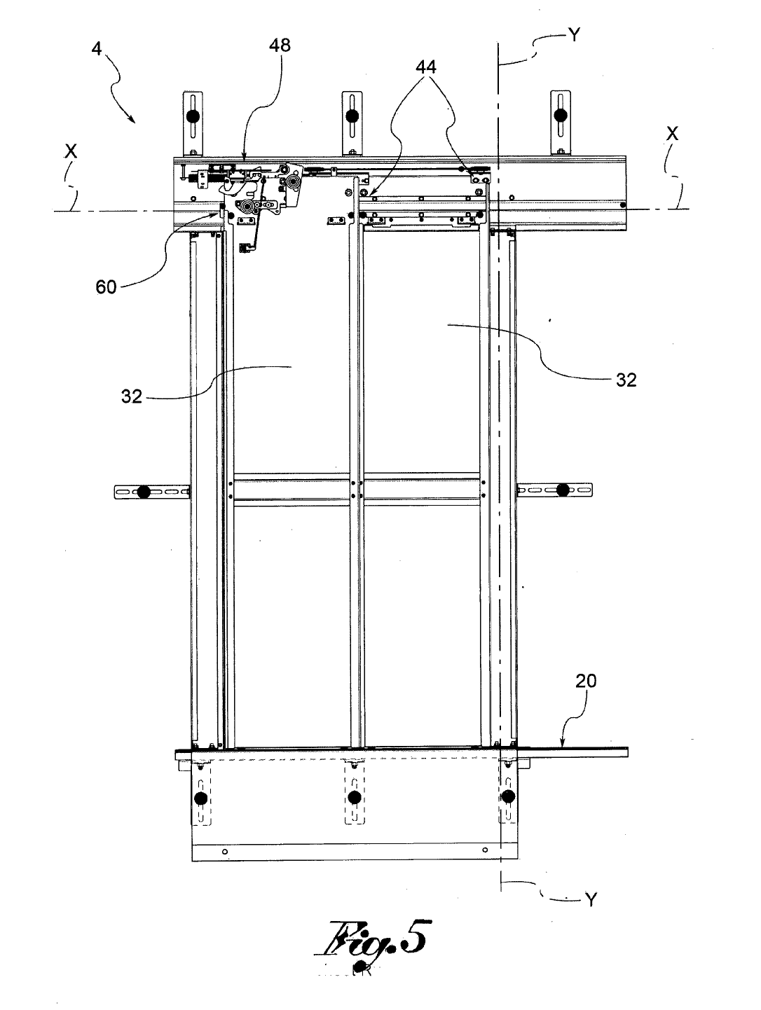

FIG. 5 shows a front view of a landing door for lifts according to a further embodiment of the present invention;

FIG. 6 shows a perspective view, in separate parts, of the door in FIG. 5;

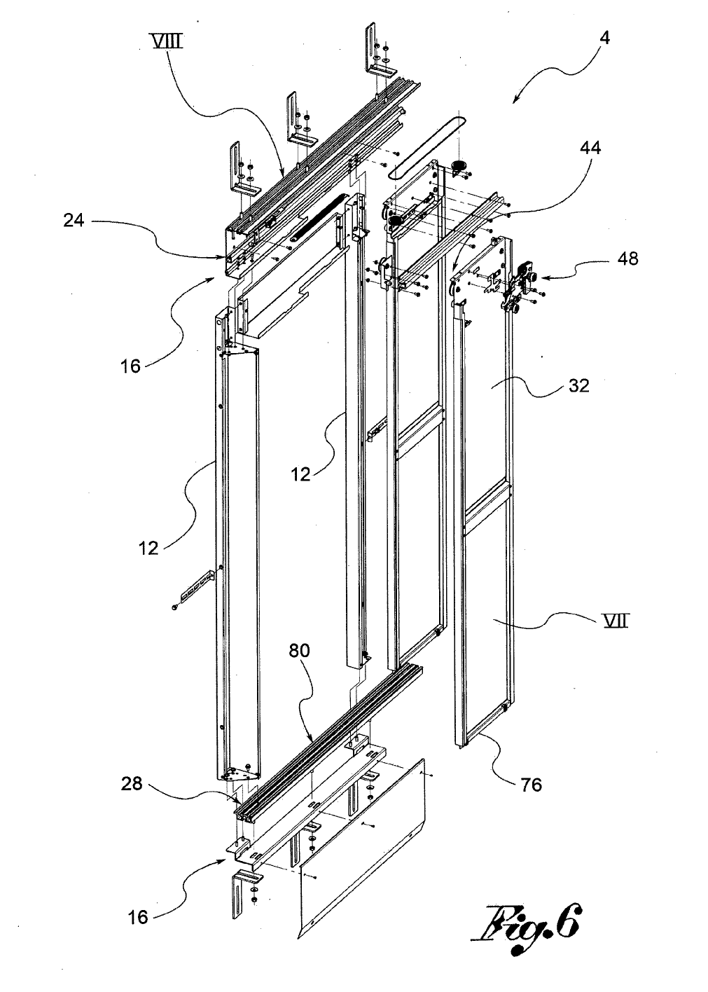

FIG. 7 shows a perspective view, from a different angle, of the detail VII in FIG. 6;

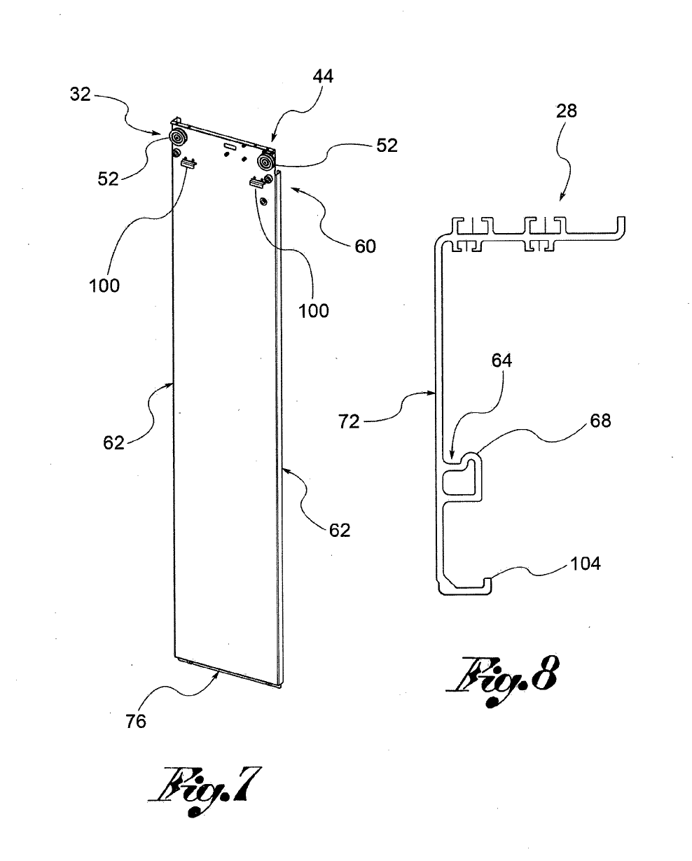

FIG. 8 shows a cross-section view of the detail VIII in FIG. 6;

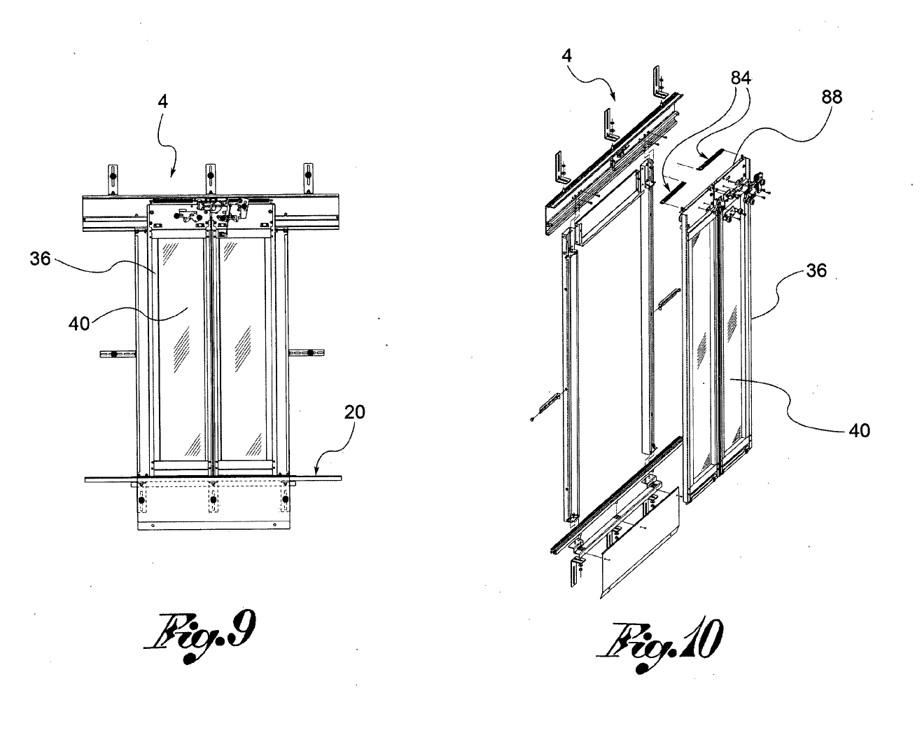

FIGS. 9-10 respectively show a view in an assembled configuration and in separate parts of a further embodiment of the present invention;

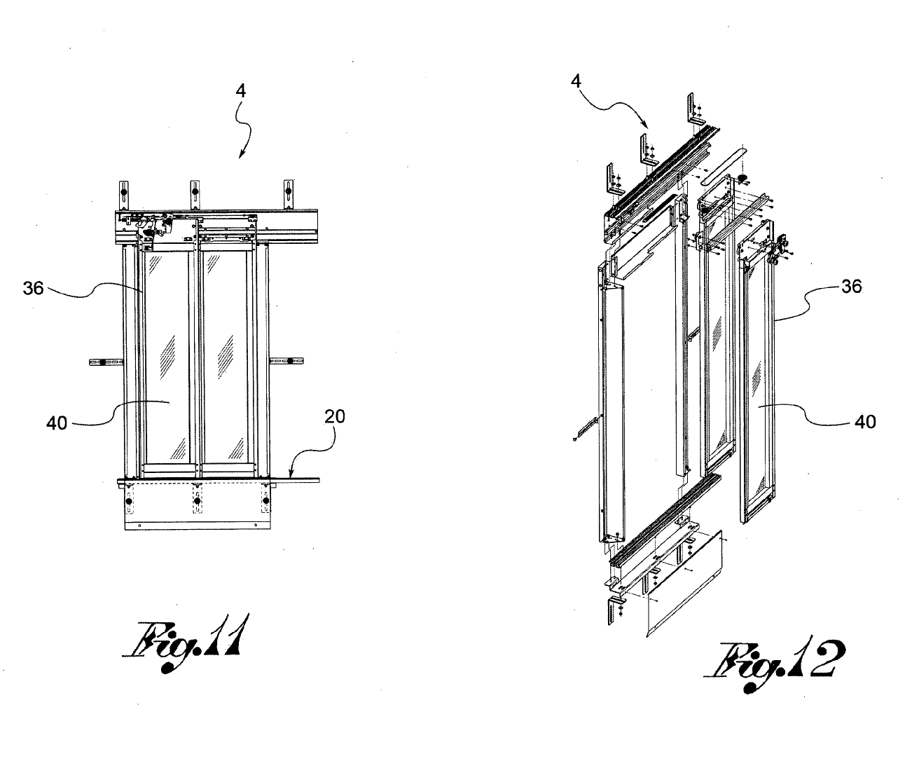

FIGS. 11-12 respectively show a view in an assembled configuration and in separate parts of a further embodiment of the present invention.

The elements or parts of elements common to the embodiments described below will be indicated using the same reference numerals.

With reference to the aforesaid drawings, reference numeral 4 globally denotes a landing or car door for lifts, comprising a frame 8 which defines the perimeter of an access aperture of the door.

The frame 8 is preferably attached to the structure, for example in brick, defining the access aperture of the landing or car door for lifts.

According to one embodiment, the frame 8 comprises a pair of uprights 12, positioned in a vertical direction Y-Y, substantially perpendicular to a ground surface 20 adjacent to the access aperture, and a pair of crossbeams 16, positioned in a horizontal direction X-X, perpendicular to the vertical direction Y-Y and parallel to the ground surface 20.

The crossbeams 16 respectively comprise an upper horizontal sliding guide 24 and a lower horizontal sliding guide 28. Said sliding guides 24, 28 extend parallel to the horizontal direction X-X.

The door 4 comprises at least two panels 32 sliding reciprocally so as to open or close the access aperture of the door 4, said panels 32 being guided by the horizontal sliding guides 24, 28 as described further below.

The panels 32 may be of the laterally or centrally sliding type, or may be of the telescopic type. The panels 32 may be panels for example in a metallic material, or may envisage an outer perimetral frame 36 to which a glass panel 40 is attached.

Advantageously, sliding devices 44 and closure devices 48 are directly attached to each panel 32 so that the panels 32 are self-supporting, that is, they do not require the interposition of further frames or support structures between said panels and the frame 8.

The sliding devices 44 couple with the horizontal sliding guides 24, 28 of the crossbeams 16 to permit and guide the opening and closing movement of the panels 32 and the closure devices are suitable to block and release the panels 32.

According to one embodiment of the present invention, the sliding devices 44 comprise a pair of roller bearings 52 mounted so as to rotate on pins perpendicular to the upper horizontal sliding guide 24. Preferably, said pins of the roller bearings 52 are directly inserted in relative seats made in the body of the panels 32, avoiding the interposition of carriages.

According to one embodiment, at least one of said roller bearings 52 is mounted on a slotted hole, made directly on the panel body 32, so as to enable the correction of misalignment of said panel.

The sliding devices 44 are positioned at an upper end 60 of the panel 32 directly facing the upper horizontal sliding guide 24. Preferably, each panel 32 comprises a pair of roller bearings 52 positioned at opposite lateral ends 62 of each panel 32.

Preferably, the horizontal sliding guide 24 comprises an upper rail 64 counter-shaped to the sliding device 44 and provided with a ridge 68 to prevent derailment of the sliding devices 44 from said guide.

In other words, the upper rail 64 is delimited between a partition 72 of the upper crossbeam 16 of the frame 8 and the ridge 68.

The sliding devices 44 comprise, at a lower end 74, at least one skate 76 which slides inside a corresponding lower rail 80 made on the lower horizontal sliding guide 28.

The skate 76 may be in a single piece without interruption, or may envisage for example, two or more separate portions of skate positioned, for example, at opposite lateral ends 62 of the panel 32.

Alternatively to the skate 76, which produces friction sliding, further roller bearings or rollers may be envisaged suitable to roll in the corresponding lower rail 80 during the opening/closing movement of the panel 32.

Preferably, the panels 32 comprise a single body which extends from an upper end 60 to a lower end 74, wherein the upper end 60 of the panel is directly facing, substantially flush, with the upper horizontal sliding guide 24 and the lower end 74 is directly facing, substantially flush, with the lower horizontal sliding guide 28.

In other words, the panels 32 comprise a single body which, at an upper end 60, directly supports the sliding devices 44 and the closure devices 48.

In yet other words, the panels 32 comprise a single body provided with seats in which attachment and support pins for the sliding devices 44 and the closure devices 48 are directly housed.

It is also possible to join to the panels 32, at said seats for the sliding devices 44 and the closure devices 48, for example reinforcement gussets, plates or washers, for example to reinforce the perimeter of the housing seats of the pins made directly on the panels 32. Such plates, gussets or washers may be directly bolted, riveted or welded to the panel body 32.

As mentioned above, closure devices 48 are directly attached to the panels 32. Said closure devices 48 comprise mechanisms to block/release the panels 32, for example of the known type.

Preferably, the closure devices 48 are positioned at the upper ends 60 of the panels 32, on an opposite side of the panel 32 to that which the sliding devices 44 are attached to.

The closure devices 48 further comprise at least one actuation rod 84 positioned on an upper rim 88 of the panel 32; the actuation rod 84 is attached directly to the panel 32 without the interposition of any frame or support structure and has a first end 92 connected to the panel and a second end 96 suitable to be influenced by motor devices of the panels 32.

According to one embodiment, the panels 32 comprise at least one safety hook 100 able to block the panel 32 to the frame 8 to prevent the derailment or escape of the sliding devices 44 from the respective sliding guides 24, 28.

For example, the safety hook is positioned on the same side of the panel as the sliding devices so as to jut out towards the frame 8. In particular, the frame 8, at the upper crossbeam 16 is fitted with a bracket 104 shaped so as to engage with the safety hook 100 and prevent derailment of the sliding devices 44 from the respective sliding guides 24,28.

Preferably, each panel 32 comprises a pair of safety hooks 100, positioned at opposite lateral ends 62.

The method of mounting a door according to the invention will now be described.

In particular, mounting of a door 4 according to the present invention initially comprises the steps of preparing and mounting the frame 8 onto the structure, for example in brick, destined to house the car.

The sliding devices 44 and closure devices 48 are then prepared and attached directly onto the panels 32 at the predefined position, making all the necessary adjustments of the panels 32 before hooking the same onto the frame. Lastly, the panels 32 are mounted on the frame with no further calibration of the door being necessary.

As may be appreciated from the description, the present invention makes it possible to overcome the drawbacks of the prior art presented.

In particular, the landing or car door is extremely easy to produce and mount.

In fact, the sliding devices are attached directly to the panel so as to avoid possible mounting errors or misalignment of such devices in relation to the panel guides. Mounting of the sliding devices is therefore always accurate and does not require lengthy and complex calibration during installation of the panels.

The absence of calibration operations is particularly useful for example when mounting panels fitted with glass, the subsequent mounting and dismantling of which could lead to accidental breakage of the glass.

Moreover, the panels also envisage direct attachment of the closure devices: in this case too mounting of the panels is facilitated and simplified.

Moreover, the correct and accurate positioning and attachment of the closure devices to the panels also ensures the correct functioning of the same after mounting the panels on the relative frame: in other words the correct alignment of the sliding devices in relation to the sliding guides ensures smooth functioning of the sliding devices and prevents possible sticking and/or derailment of the panels.

It follows that mounting of the doors is 30% faster than the solutions of the prior art and that production and assembly costs are reduced by 50% compared to the solutions of the prior art.

Moreover, the doors according to the present invention are safe thanks to the presence of the safety hooks which prevent accidental falling of the panels even following derailment of the sliding devices from the respective sliding guides.

Moreover, direct mounting of the sliding devices to the panels, without the use of frames or support brackets, helps to lighten the weight of the panels and therefore of the lift door.

Lastly, the present invention can also be applied to pre-existing doors fitted with support carriages and panel guides: in other words, “retrofitting” can be performed, replacing the doors of the prior art fitted with relative support carriages and guides with the panels according to the present invention.

A person skilled in the art may make numerous modifications and variations to the doors described above so as to satisfy contingent and specific requirements while remaining within the sphere of protection of the invention as defined by the following claims.

1-16. (canceled)

17. A landing or car door for lifts, comprising:
a frame which defines the perimeter of an access aperture of the door, the frame comprising a pair of uprights and a pair of crossbeams, the crossbeams respectively comprising an upper horizontal sliding guide and a lower horizontal sliding guide,
at least two reciprocally sliding panels to open and close the access aperture of the door,
wherein a sliding device and a closure device are directly attached to each panel so that the panels are self-supporting, wherein the sliding device couples with the sliding guides of the crossbeams to permit and guide opening and closing movements of the panels and the closure device is suitable for blocking and releasing the panels,
wherein the upper horizontal sliding guide comprises an upper rail counter that is shaped to the sliding device and provided with a ridge to prevent derailment of the sliding device from said sliding guides,
wherein the panels comprise at least one safety hook to prevent derailment of the sliding device from its respective sliding guide, and
wherein the safety hook juts out from the panel towards the frame and the frame is fitted with a corresponding bracket which engages with the safety hook to prevent derailment of the sliding device from its respective sliding guide.

18. The door of claim 17, wherein the panels comprise a single body which extends from an upper end to a lower end, wherein the upper end of the panel is directly facing and substantially flush with the upper horizontal sliding guide and the lower end is directly facing and substantially flush with the lower horizontal sliding guide.

19. The door of claim 17, wherein the panels comprise a single body which, at an upper end, directly supports the sliding device and the closure device.

20. The door of claim 17, wherein the panels comprise a single body provided with seats in which attachment and support pins for the sliding device and the closure device are directly housed.

21. The door of claim 17, wherein the sliding device comprises a pair of roller bearings mounted so as to rotate on pins perpendicular to the upper horizontal sliding guide, said pins being directly inserted in seats made in the body of the panels avoiding the interposition of carriages.

22. The door of claim 17, wherein said sliding device is positioned at an upper end of the panel directly facing the upper horizontal sliding guide.

23. The door of claim 17, wherein the sliding device comprises a skate which slides inside a corresponding lower rail made on the lower horizontal sliding guide.

24. The door of claim 17, wherein the closure devices further comprise at least one actuation rod positioned on an upper rim of the panel, the actuation rod being attached directly to the panel without interposition of any frame or support structure.

25. The door of claim 24, wherein said actuation rod comprises a first end connected to the panel and a second end adapted for being influenced by motor devices of the panels.

26. The door of claim 17, wherein the panels are arranged to slide centrally or laterally.

27. The door of claim 17, wherein the panels are of the telescopic type.

28. The door of claim 17, wherein the panels comprise an outer perimetral frame to which a glass pane is attached.

29. A method of mounting a door according to claim 17, comprising the steps of:
preparing and attaching a perimetral frame to a relative support structure,
preparing sliding devices and closure devices of the panels,
attaching the sliding devices and closure devices directly to the panels,
adjusting and calibrating the panels before attaching them to the frame, and
mounting the panels on the frame.
